(19) United States
(12) Patent Application Publication
(10) Pub. No.: US 2014/0172548 A1
(43) Pub. Date: Jun. 19, 2014

(54) PROVIDING NOTIFICATIONS OF USER SELECTION OF ADVERTISEMENTS

(71) Applicant: Rodney O. Garlick, West Point, UT (US)

(72) Inventor: Rodney O. Garlick, West Point, UT (US)

(73) Assignee: Virtual Keyring, LLC, West Point, UT (US)

(21) Appl. No.: 13/774,441

(22) Filed: Feb. 22, 2013

Related U.S. Application Data
(63) Continuation-in-part of application No. 13/718,931, filed on Dec. 18, 2012.

(51) Int. Cl. G06Q 30/02

(52) U.S. Cl. CPC G06Q 30/0246; H04L 63/083
USPC 705/14.45; 726/7

(57) ABSTRACT

The present invention is generally directed to providing notifications when a user selects an advertisement. The advertisements can be displayed in an interface such as a webpage that provides password management. The advertisements can be related to goods or services provided by an entity that sponsors the webpage. When the user selects an advertisement, one or more notifications can be generated and sent to the entity and/or the user. These notifications can be used to increase the likelihood that the user will purchase the goods or services advertised, as well as to evaluate the effectiveness of an advertisement. The present invention also extends to rotating the source of advertisements that are displayed in a webpage. The present invention further extends to verifying user credentials that are provided for logging in to a website, and automatically logging a user out of a website once the user credentials have been verified.

### CROSS-REFERENCE TO RELATED APPLICATIONS

This application is a continuation-in-part of U.S. patent application Ser. No. 13/718,931, filed Dec. 18, 2012, and titled “Cloud Based Password Management.”

### BACKGROUND

1. Field of the Invention

The present invention extends to methods, systems, and computer program products for providing notifications when a user selects an advertisement.

2. Background and Related Art

With the increasing amount of online interaction available today, a typical individual must maintain login credentials for a large number of websites. It is generally recommended that an individual maintain strong credentials especially to websites that provide access to sensitive data. However, it is difficult to remember each set of login credentials for every site with which the individual has an account.

To address this difficulty, many individuals use password managers. A password manager is a tool that stores a user's login credentials for various websites, and can generally be used to automatically populate the login fields of a website with the appropriate set of credentials.

Many current password managers use some type of plug-in or other module installed locally on the user's computer to perform these functions. These password managers often maintain a cloud based repository for storing a master copy of a user's credentials. However, to use such password managers to automatically populate the login fields of a website being accessed on a local computer, the plug-in must be installed on the local computer.

For example, LastPass, a currently popular password manager, employs a browser plug-in. The browser plug-in detects when a user has navigated to a website for which LastPass stores the user's credentials, and can automatically populate the website's login fields with the user's credentials. After auto-populating the login credentials, LastPass can also cause the credentials to be submitted (e.g. by causing the submission of the HTTP POST request that is invoked when the submit button is clicked) to the website to cause the user to be automatically logged in to the website.

LastPass maintains a cloud based repository where each user's login credentials are stored and can be accessed from any computer. However, without installing the browser plug-in on a local computer, the automatic population of credentials and the automatic submission of login requests cannot be performed on the local computer.

Password managers like LastPass are effective when a user is using the same computer or computers where the plug-in has been installed. However, if the user is ever using a different computer on which the plug-in is not installed, the user cannot employ the password managers to automatically populate credentials or automatically log in. These password managers will allow the user to access the cloud based repository to view the credentials, but the user will have to enter the credentials and log in manually as when no password manager is used. Therefore, even though many of these password managers claim to provide access to login credentials from anywhere or any device, they do not provide the key benefit of automatic login from any device on which the plug-in has not been installed.

Accordingly, it would be an improvement in the art to augment or even replace current techniques with other techniques.

### BRIEF SUMMARY

The present invention extends to methods, systems, and computer program products for providing notifications when a user selects an advertisement. The advertisements can be displayed in an interface such as a webpage that provides password management. The advertisements can be related to goods or services provided by an entity that sponsors the webpage. When the user selects an advertisement, one or more notifications can be generated and sent to the entity and/or the user. These notifications can be used to increase the likelihood that the user will purchase the goods or services advertised, as well as to evaluate the effectiveness of an advertisement.

The present invention also extends to rotating the source of advertisements that are displayed in a webpage. The present invention further extends to verifying user credentials that are provided for logging in to a website, and automatically logging a user out of a website once the user credentials have been verified.

In one embodiment, the present invention provides a method for generating notifications of a user's selection of an advertisement. A first notification is received from a client computing system. The first notification indicates that a user has selected an advertisement being displayed on the client computing system, and includes an identification of the user and an identification of the advertisement that was selected. Based on the identification of the user, contact information of the user is identified. Based on the identification of the advertisement, contact information of a sponsor that is associated with the advertisement is also identified. A second notification is then generated that identifies that the user has selected the advertisement. The second notification is then sent to an address contained within the contact information of the sponsor that is associated with the advertisement.

In another embodiment, the present invention is implemented as one or more computer storage media storing computer executable instructions which implement a webpage. The computer executable instructions include: logic which, when executed by one or more processors, renders a webpage. The webpage includes a frame in which one or more advertisements are displayed; logic which causes the webpage to request a first advertisement from a first source to be displayed in the frame; and logic which, after the first advertisement has been displayed in the first frame for a specified period of time, causes the webpage to refresh the frame and, as part of the refresh, request a second advertisement from a second source to be displayed in the frame in place of the first advertisement.

In another embodiment, the present invention is implemented as a method for verifying user credentials for a particular website. A request is received, from a user, to add a first website to a password manager system, the request providing user credentials for logging in to the first website. Logic, stored on the server computing system, is accessed. The logic defines interactions to be performed with a server computing system that hosts the first website to log the user in to the first website. The logic is executed to perform the interactions using the user credentials. An instance of the first website is received, the user being logged in to the instance of the first website. Logic, stored on the server computing system, is accessed, the logic defining interactions to be performed with the server computing system that hosts the first website to log the user out of the first website. The logic is then executed to log the user out of the first website.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a representative computer environment in which the present invention can be implemented;

FIG. 2 illustrates a server system and a client computing device of the computer environment of FIG. 1;

FIG. 3 illustrates a flow diagram of the process performed by logic stored on a server system when a request to log in to a website is received;

FIGS. 4A-11B illustrate various representative user interfaces that can be displayed to a user to facilitate the use of the present invention;

FIG. 12 illustrates an example of a website that displays advertisements which when selected generate notifications;

FIG. 13 illustrates a flow diagram of the process of generating notifications when a user selects an advertisement;

FIG. 14 illustrates an example of a notification that can be sent to a sponsor of a website on which an advertisement is selected; and

FIG. 15 illustrates an example of how the source of an advertisement can be rotated.

### DETAILED DESCRIPTION

The present invention extends to methods, systems, and computer program products for providing notifications when a user selects an advertisement. The advertisements can be displayed in an interface such as a webpage that provides password management. The advertisements can be related to goods or services provided by an entity that sponsors the webpage. When the user selects an advertisement, one or more notifications can be generated and sent to the entity and/or the user. These notifications can be used to increase the likelihood that the user will purchase the goods or services advertised, as well as to evaluate the effectiveness of an advertisement.

The present invention also extends to rotating the source of advertisements that are displayed in a webpage. The present invention further extends to verifying user credentials that are provided for logging in to a website, and automatically logging a user out of a website once the user credentials have been verified.

In one embodiment, the present invention provides a method for generating notifications of a user's selection of an advertisement. A first notification is received from a client computing system. The first notification indicates that a user has selected an advertisement being displayed on the client computing system, and includes an identification of the user and an identification of the advertisement that was selected. Based on the identification of the user, contact information of the user is identified. Based on the identification of the advertisement, contact information of a sponsor that is associated with the advertisement is also identified. A second notification is then generated that identifies that the user has selected the advertisement. The second notification is then sent to an address contained within the contact information of the sponsor that is associated with the advertisement.

In another embodiment, the present invention is implemented as one or more computer storage media storing computer executable instructions which implement a webpage. The computer executable instructions include: logic which, when executed by one or more processors, renders a webpage. The webpage includes a frame in which one or more advertisements are displayed; logic which causes the webpage to request a first advertisement from a first source to be displayed in the frame; and logic which, after the first advertisement has been displayed in the first frame for a specified period of time, causes the webpage to refresh the frame and, as part of the refresh, request a second advertisement from a second source to be displayed in the frame in place of the first advertisement.

In another embodiment, the present invention is implemented as a method for verifying user credentials for a particular website. A request is received, from a user, to add a first website to a password manager system, the request providing user credentials for logging in to the first website. Logic, stored on the server computing system, is accessed. The logic defines interactions to be performed with a server computing system that hosts the first website to log the user in to the first website. The logic is executed to perform the interactions using the user credentials. An instance of the first website is received, the user being logged in to the instance of the first website. Logic, stored on the server computing system, is accessed, the logic defining interactions to be performed with the server computing system that hosts the first website to log the user out of the first website. The logic is then executed to log the user out of the first website.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

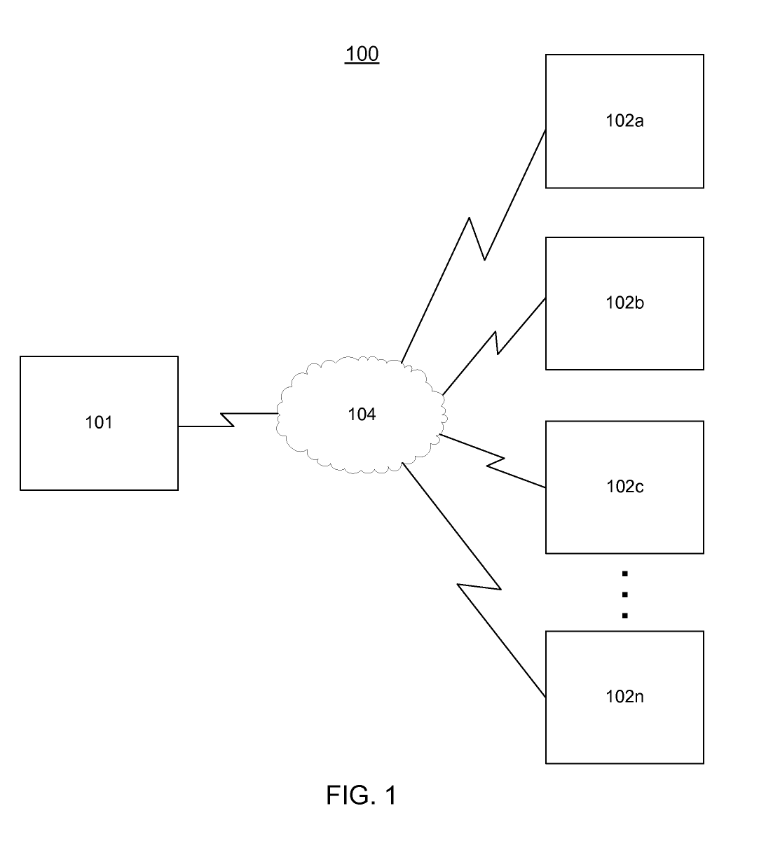

FIG. 1 illustrates an representative computer environment 100 in which the present invention can be implemented. Computer environment 100 includes server system 101, and client computing devices 102a-102n that are connected to server system 101 over network 103. Server system 101 can represent any number of interconnected computing components. For example, server system 101 can represent a single server computing device or a cloud of interconnected server computing devices or components. Client computing devices 102a-102n represent any type of device that can access server system 101 over network 103. For example, any of client computing devices 102a-102n can be a smart phone, tablet, laptop, desktop, or any other type of computing device that accesses server system 101 over the internet.

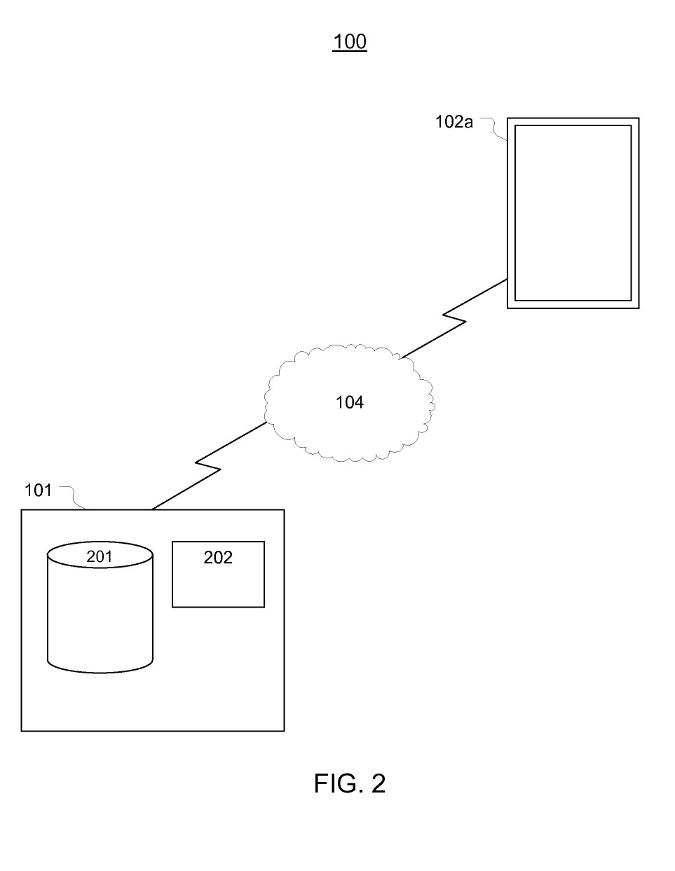

FIG. 2 illustrates a more detailed view of server system 101 and client computing device 102a which is represented as a tablet. As shown, server system 101 maintains a repository 201 for storing the various users' login credentials. Server system 101 also comprises login request processing logic 202. Logic 202 is configured to receive requests from client computing devices 102a-102n to log in to one or more websites, access the login credentials in repository 201, and perform the required interaction with the requested website to log the user in to the website.

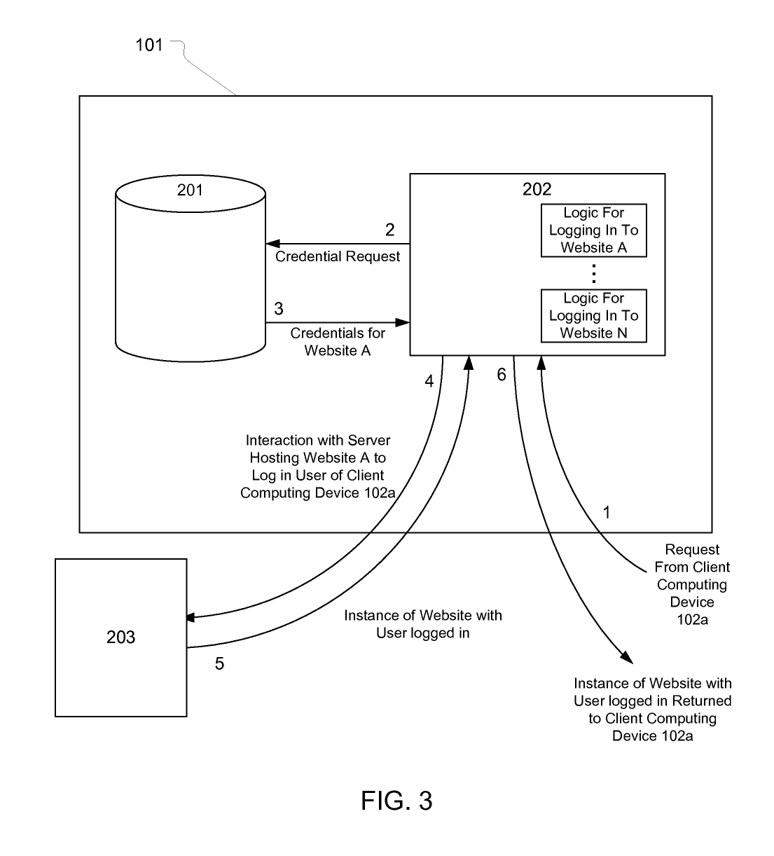

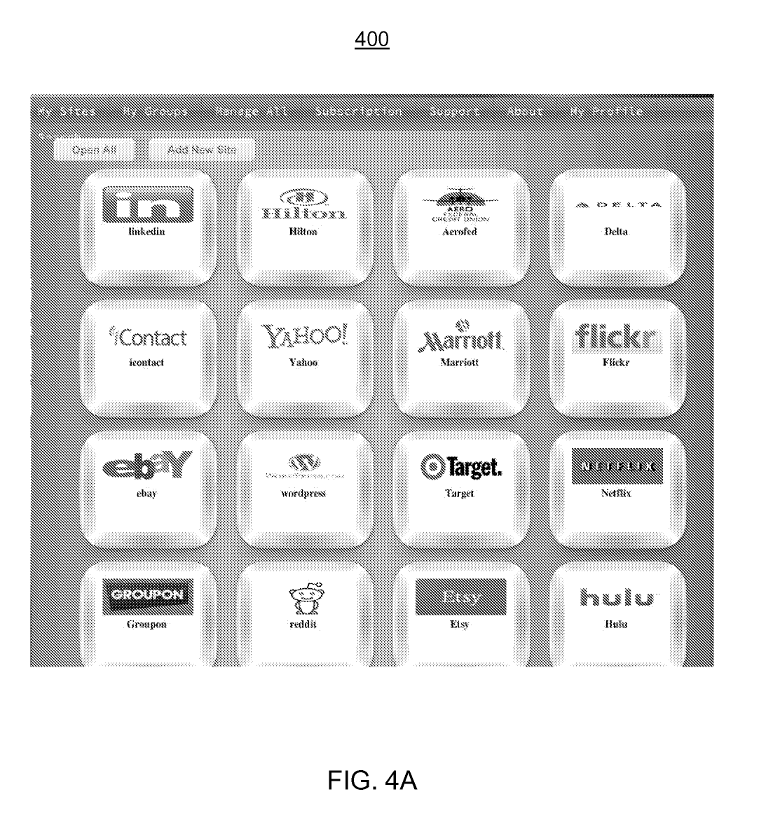

FIG. 3 illustrates a flow diagram 300 which represents the process performed by logic 202 when a request to log in to a website A is received from a user of computing device 102a. Flow diagram 300 shows six general steps of this process.

First, a request is received from client computing device 102a to access website A. This request can be sent to server 101 in response to a user inputting a URL or selecting a representation (e.g. an icon, a link, etc) of website A from a webpage, app, or other interface being displayed on client computing device 102a.

Second, in response to the request, logic 202 identifies website A in the request and requests or otherwise accesses the user's credentials for website A from repository 201. Third, the credentials for website A are received from repository 201.

Fourth, logic 202 includes logic for logging in to website A which is used to interact with a server hosting website A to log the user into website A. Because each website may require different steps for logging in, logic 202 can include necessary logic to perform the required steps for logging in to any of the websites for which server 101 maintains login credentials. In some embodiments, logic 202 comprises an API based routine configured to log in to a specific website.

For example, the steps for logging in to a banking website may be different than the steps for logging in to an email account. These steps can include a single request that includes the user's credentials, or multiple tiered requests that each may require a different credential or combination of credentials to log the user in. Accordingly, for each website that a user may attempt to log in to, logic 202 can include necessary logic for interacting with the appropriate server to perform the steps to log the user in.

In a particular example, logic 202 can be configured to know the format and content of an HTTP Post request that a particular website expects to receive in a login request. In such cases, logic 202 can include or have access to a generic HTTP Post request for website A (e.g. in any necessary format such as SOAP, JSON, HTML, etc.). Logic 202 can customize the request with a user's username and password content so that, when server 101 submits the customized HTTP Post request, server 101 receives back a version of website A with the user logged in. Of course, other types of requests and/or content can be used as required by a particular website.

Fifth, once the necessary interactions have occurred between server 101 and the server hosting website A to log the user in, an instance of the website with the user logged in is returned to server 101. This instance of the website can be the same as if the user had manually logged in to the website directly from client computing device 102a.

Sixth, this instance of the website with the user logged in is returned to client computing device 102a where the user can interact with the website as if he had manually logged in on client computing device 102a. In this manner, each of the steps required to log the user in to a website is performed on server system 101 thereby eliminating the need for any download, plug-in, or other locally executing logic to perform automatic login on client computing device 102a.

As such, by implementing the present invention, the user of client computing device 102a could use any other client computing device in the manner described above to be automatically logged in to a website. In contrast, current password managers require a local plug-in, software, or other module which performs the interactions with the website to log the user in. In other words, using other password managers, an instance of the website without the user logged in is returned to the client computing device. Then, the plug-in on the client computing device populates the log in fields and submits the credentials to receive a logged in instance of the website. Therefore, using these current password managers, if the user switched to another client computing device, the user would have to first install a plug-in or other module on the other client computing device before being able to be automatically logged in to a website.

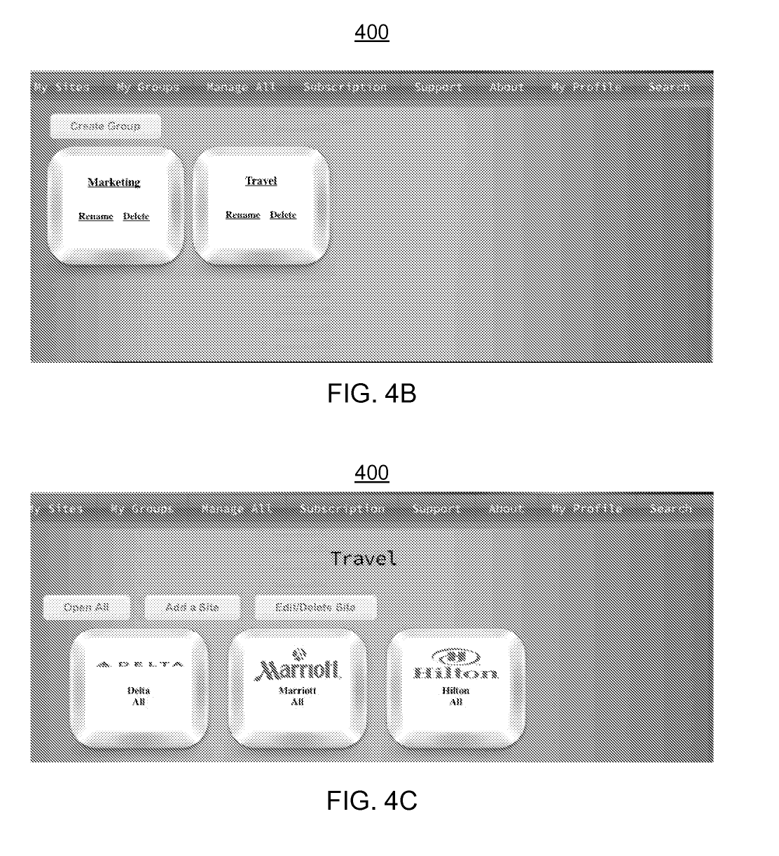

FIG. 4A illustrates an representative user interface 400 that server system 101 can provide to client computing device to allow a user to make requests to access a website. User interface 400 can be in the form of a webpage, an app, or other user interface. User interface 400 includes a plurality of tiles. Each of the tiles represents a website for which server system 101 stores login credentials for the user. Other display formats could be used instead of tiles such as different sized icons, lists, etc. In some embodiments, user interface 400 can provide an option to customize the display of the representations of the websites.

By selecting one of the tiles, a request can be sent to server system 101 to receive an instance of the associated website with the user logged in. After a tile is selected on a client computing device, the client computing device receives an instance of the website with the user logged in without requiring the client computing device to perform any action other than to submit the request for the website, receive the instance of the website, and display it.

FIG. 4B illustrates representative user interface 400 with an option to request a group of websites. For example, user interface 400 can allow a user to group together two or more websites and then make a single request to open all websites in the group. As shown in FIG. 4B, a group has been created for Marketing and Travel. FIG. 4C shows user interface 400 after the Travel group has been opened. The Travel group includes three websites, and therefore, three tiles are displayed. When the Travel group is selected, all three websites are automatically opened with the user logged in.

It is also possible to include one or more websites in a group that do not require login credentials. For example, a user may include a banking website, an investing website, and a stock market website in a group even when the stock market website does not require login credentials. When the group is selected, the banking and investing website can be requested as described above to receive an instance of each website with the user logged in. Server 101 can also request a generic instance of the stock market website and return it with the instances of the banking and investing websites.

In some embodiments, whether a generic or logged in instance of a website is returned to a client computing device can be configured by the user. For example, the user may specify that he desires to include a website in user interface 400 that requires login credentials, but does not desire to supply the login credentials. This may be the case, for example, when the user desires to access a banking website with which the user has an account, but does not desire to be logged in to the website each time he accesses the website. In such cases, logic can be stored on server system 101 or included in a request sent to server system 101 that specifies whether to log the user in to a website in response to a request for the website.

In some embodiments, server system 101 can log users in at different levels. In other words, certain websites may require multiple tiers of authentication. For example, many banking websites require the user to enter a username and password in a first screen, and then enter additional credentials in a second screen to log in. In such cases, server system 101 can perform the first step of logging the user in through the first tier (e.g. submit the user name and password), but can then return an instance of the website having the user logged in to the second tier (e.g. returning the screen that prompts the user to enter the additional criteria). The individual logic on server system 101 for logging in to a website can be configured appropriately to perform a desired level of authentication on behalf of the user.

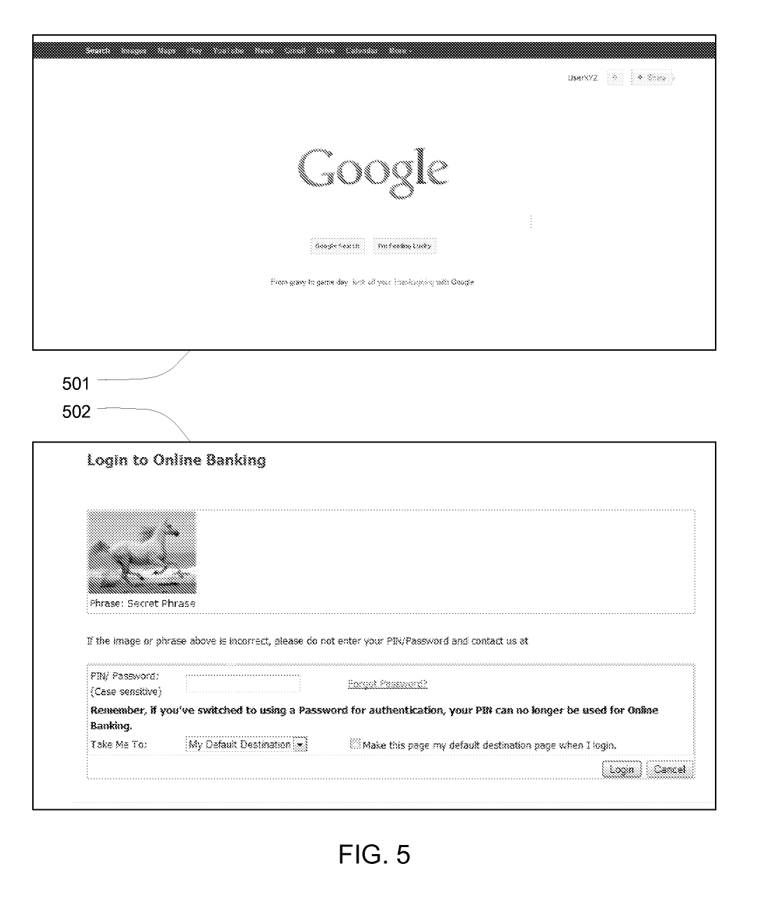

FIG. 5 illustrates two representative instances of websites that server system 101 can return to a client computing device. Instance 501 represents the case where the user is fully logged in to the website by server system 101. As such, instance 501 shows that the user is logged in as UserXYZ.

Instance 502 represents the case where the user has been logged in to a website through a first tier of a two tier authentication scheme. Instance 502 shows that the user is not fully logged in, but requires that the user manually enter additional credentials to complete logging in.

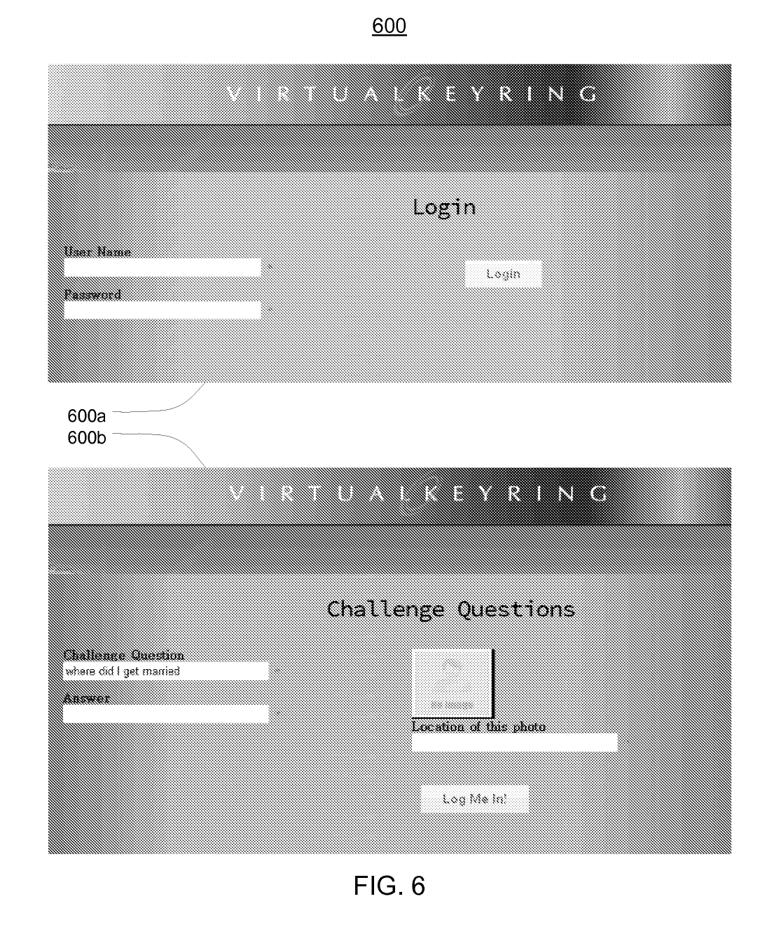

FIG. 6 illustrates a representative user interface 600 that server system 101 can provide to allow a user to log in to the service provided by server system 101. Because server system 101 stores the user's sensitive log in credentials, server system 101 can require multiple tier authentication before the user can make requests to access websites. In some embodiments, this multiple tier authentication can comprise a three tiered approach which requires a username and password, an answer to a challenge question, and the identification of a location where a photo was taken.

As shown in FIG. 6, initially user interface 600a prompts the user to input a username and password combination. Then, user interface 600b displays a challenge question and a photo with a prompt to answer the challenge question and to identify the location where the photo was taken. In this way, the multiple tier authentication requires a user to know many different types of information thus making it difficult to unlawfully gain access to another user's account.

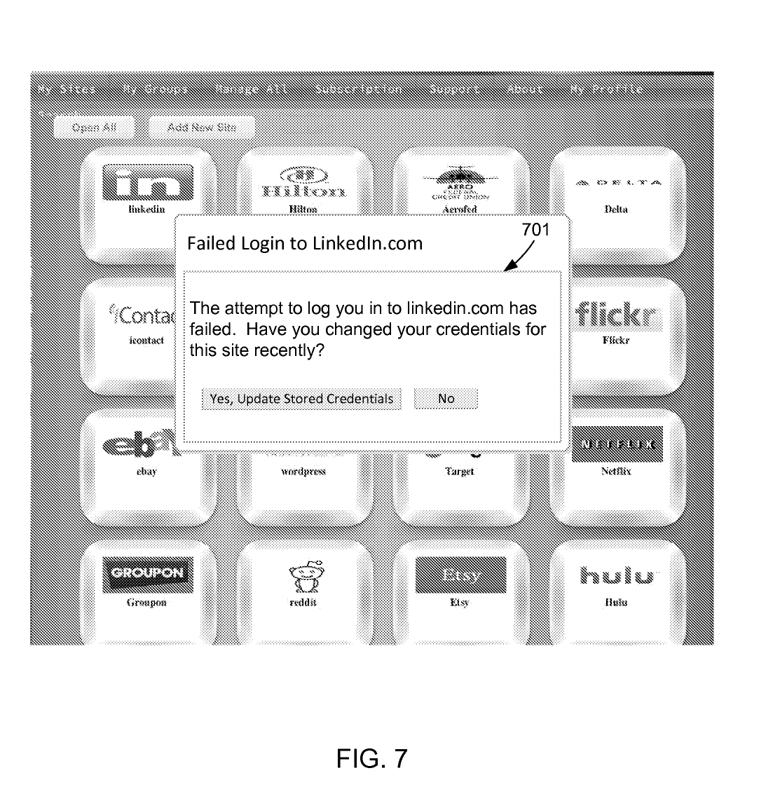

FIG. 7 illustrates a representative user interface 700 provided by server system 101 to inform the user that credentials stored for a website are no longer valid. As shown, user interface 700 includes a dialog 701 which notifies the user that login has failed and asks the user whether the user recently changed the credentials (e.g. password) for the website. In some embodiments, dialog 701 can also include a link to an interface for updating the stored credentials. In this way, the user can quickly access the necessary interface to update any stored credentials that the user has updated with the corresponding website.

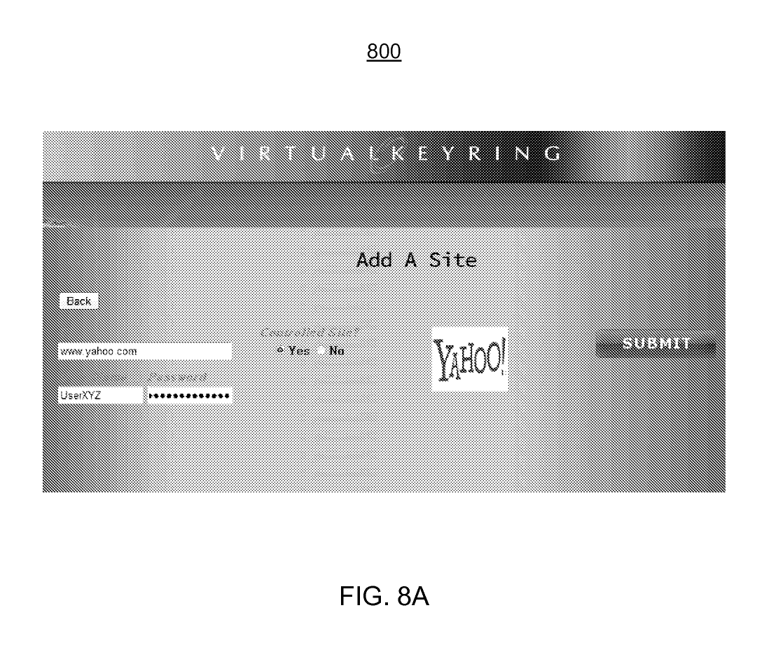

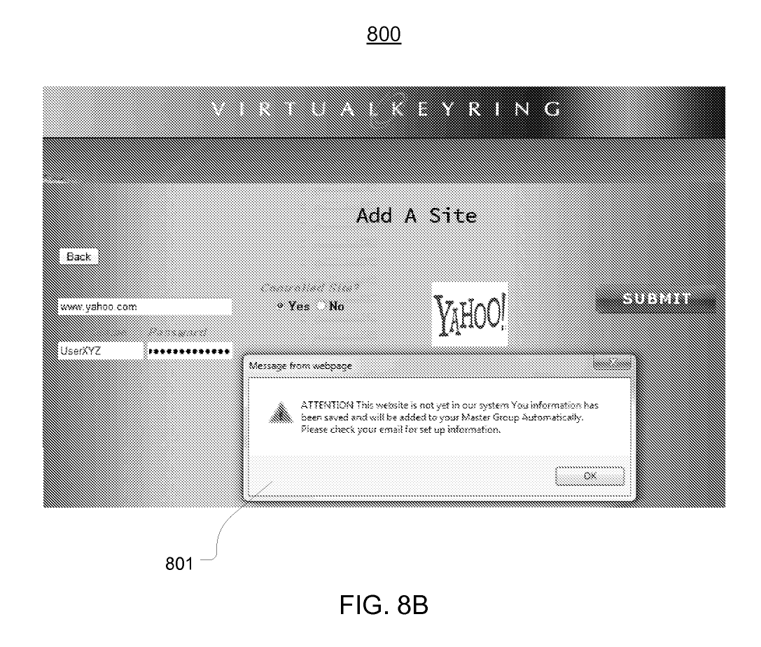

FIG. 8A illustrates a representative user interface 800 provided by server system 101 to allow the user to add credentials for a new website. User interface 800 includes fields for specifying the URL of the website and the credentials for the website. In some embodiments, when the user submits a request to add a new website, server system 101 can determine whether it stores logic for automatically logging a user in to the website. Specifically, because server system 101 is configured with logic for performing all the necessary steps to obtain an instance of a website with the user logged in, and because each website may require different steps, it is necessary that server system 101 contain the appropriate logic for each website.

As shown in FIG. 8B, if a user requests to add a new website for which server system 101 has not yet been configured to obtain logged in instances, a dialog 801 can be displayed to the user to inform the user that the user cannot currently be logged in to the website, but that the user will be notified when server system 101 is configured to perform automatic login to the website. As shown in dialog 801, this notification can be in the form of an email to the user once server system 101 has been updated with the necessary logic. Other forms of notification could also be used.

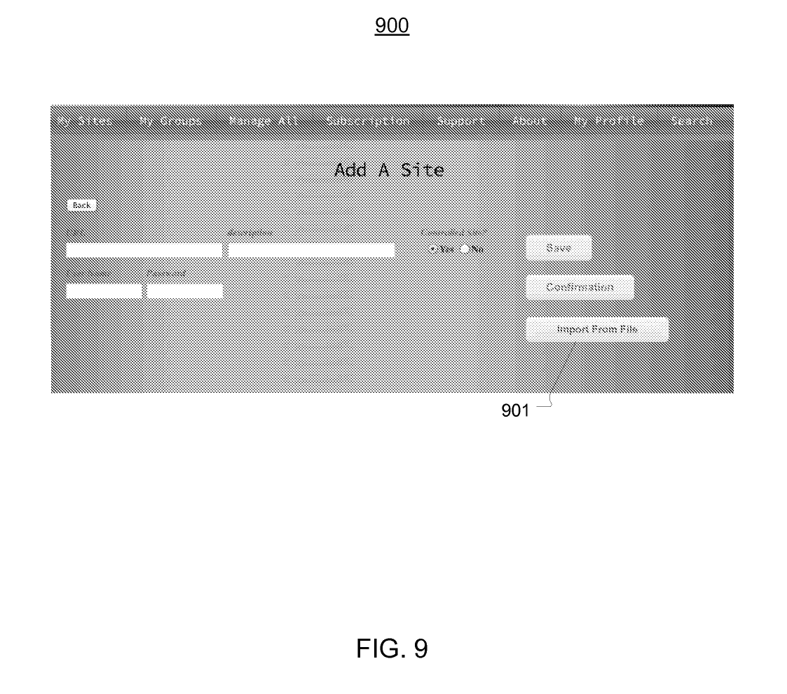

FIG. 9 illustrates a representative user interface 900 provided by server system 101 that includes a button 901 that allows the user to import credentials maintained in a separate file. For example, a user may maintain credentials in a spreadsheet, word processing, or other type of document. User interface 900 provides a way for the user to submit such files to server system 101 to allow server system 101 to automatically import the credentials in the files into repository 201. When button 901 clicked, user interface 900 can displays instructions for assisting the user in formatting the file appropriately to match mappings used by server system 101, or may provide controls for allowing the user to define custom mappings to the format of the file. For example, user interface 900 can include controls to allow the user to define which columns or rows of a spreadsheet include usernames or passwords.

Regardless of the method the user employs to add a new website, the password manager of the present invention, as described above, ties the user's credential for the website into a sign-in program that, when the user requests the website, automatically requests a copy of the website with the user logged in and returns the logged in copy of the website to the user. In this way, the user's credentials are stored in the cloud, and the login process occurs completely in the cloud so that the no dedicated software, plug-in, or app is required on the user's device. The user simply selects a website from any computing device and receives a logged in copy of the website.

In some embodiments, the above described user interfaces can be portions of a website provided by another company. For example, a banking institution can provide a portal for its customers that includes user interface 400 to allow the customers to access any of their websites from the banking institution's website.

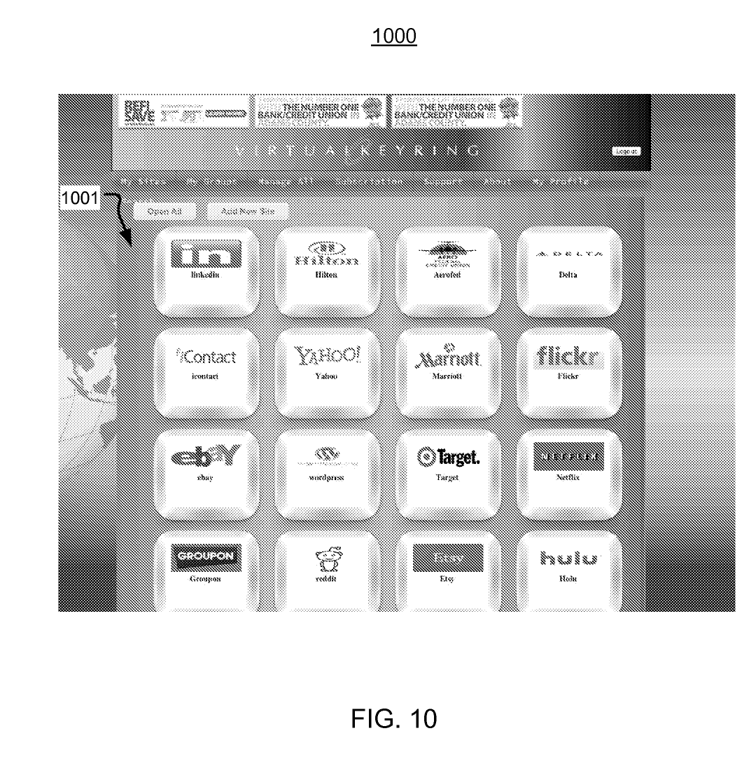

FIG. 10 illustrates a representative portal website 1000 of a banking institution that includes user interface 1001 for making requests to server system 101. User interface 1001 can be similar to user interface 400. Portal website 1000 can include advertisements that are targeted to the customer of the banking institution. In this way, the banking institution can attract customers to visit the portal website more frequently and therefore view the advertisements more frequently.

For example, by including user interface 1001 to its customers, the banking institution can encourage its customers to use the banking institution's website as their primary portal to other websites on the internet. Portal website 1000 can be configured to display advertisements that are custom tailored for each customer such as advertisements promoting a banking product that the banking institution is not currently providing to the customer (e.g. offering a credit card to a customer that only has a checking account with the institution). Accordingly, the present invention can be implemented by embedding an interface for accessing server system 101 within a website of another entity.

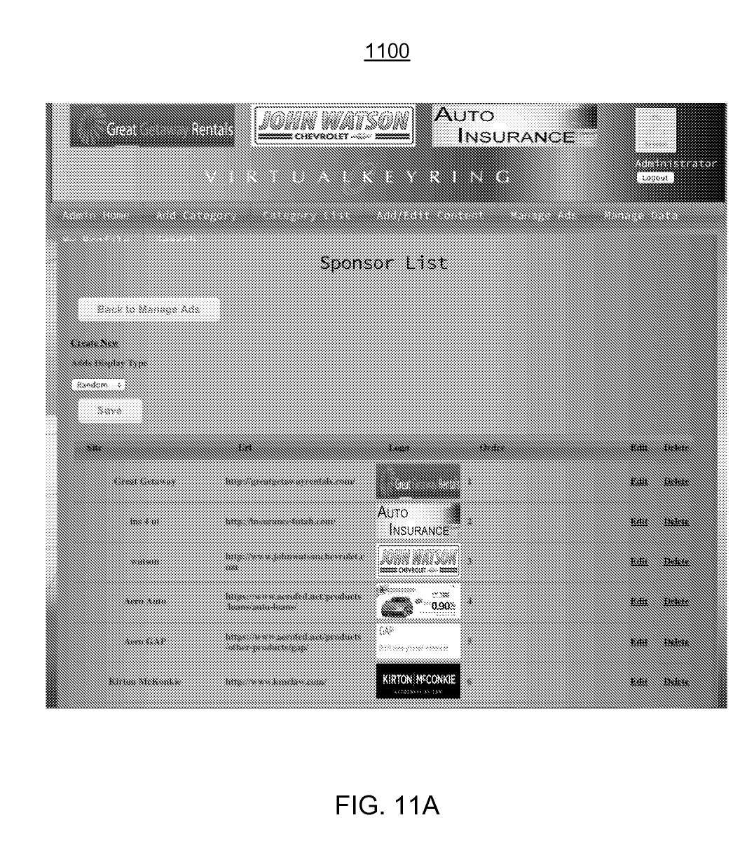

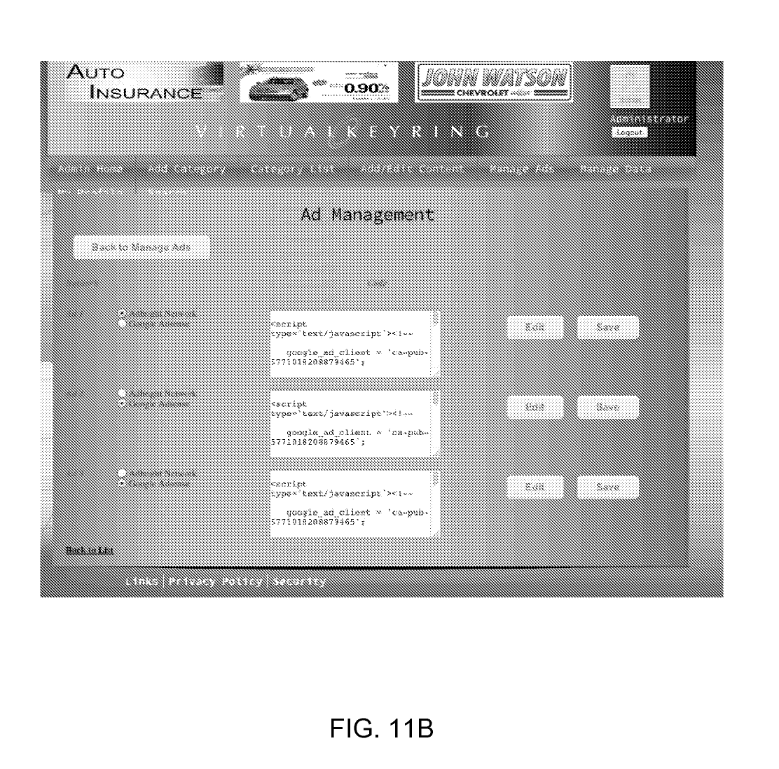

The present invention can provide an interface to allow a bank or other portal owner to customize the display of advertisements on portal website 1000. For example, FIG. 11A illustrates a representative user interface 1100 that lists a plurality of ads that are to be displayed in portal website 1000. FIG. 11B also shows that advertisements from internet ad networks can also be managed via user interface 1100.

In some embodiments, the present invention can also provide a site monitor feature. The site monitor feature monitors websites for which credentials are stored and can detect when the user is logged in to a website on a computer other than the computer the user is currently using to access the password management tool. For example, if a user logged in to Facebook on a computer at the Apple Store, forgot to logout, and then logged into the password management tool using a work computer, the site monitor feature of the present invention can check the login status for any websites monitored for the user, and notify the user accordingly. The site monitor feature can also provide an option to log the user out from his connection on the other computer. This can prevent unauthorized access by another person in such situations.

The site monitor feature can detect whether a user is logged in to a particular website using similar techniques described above for logging the user in to the website. For example, because the way to determine whether a user is logged in to a website on another computer may be different for each website, logic 202 can also include the necessary logic to check the login status of each website.

For example, for some websites, the content of the website returned to server 101 when server 101 attempts to log the user in may be different when the user is logged in elsewhere than when the user is not logged in anywhere else. Logic 202 can be configured to detect any differences in the content to determine that the user is logged in elsewhere, and can also include logic for logging the user out (e.g. logic to identify and invoke a log out button on the website).

Verifying Username and Password when User Adds New Site

In some embodiments, when a user adds a website (e.g. as shown in FIG. 8A), a verification process can be performed to ensure that the username and password supplied by the user is valid for the added website. This verification process can involve logging the user in to the website in the manner described above. If this login process fails, the user can be notified so that the user can supply the correct username/password. In this manner, the present invention can quickly verify that the user has supplied valid credentials for the added website.

Additionally, if the user's credentials are valid, and the login attempt is successful, the user will be logged in to the website (e.g. via server system 101). It is undesirable to leave the user logged in via server system 101 after the user credentials are verified. Accordingly, the present invention, after verifying the user's credentials, can perform the appropriate functionality to cause the user to be logged out from the website. The functionality required to log out may be different for each website. Therefore, server system 101 can store appropriate logic, for each website, to log the user out from the website (e.g. with the logic for logging in to the website).

Providing Notifications when a User Selects an Advertisement

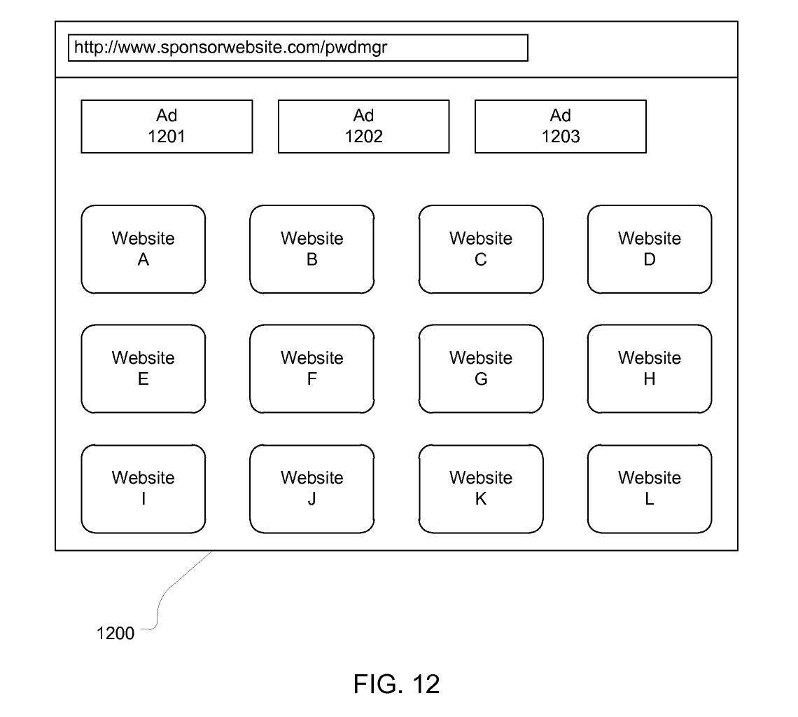

FIG. 12 illustrates an example website 1200 provided by a sponsor that offers a password manager service (www.sponsorwebsite.com/pwdmgr). For example, a bank or other entity can provide website 1200 to its members. In some embodiments, the password manager service provided at website 1200 can be similar to the service described above. However, the provision of notifications when a user selects an advertisement can be implemented on other websites that do not offer a password manager service. Accordingly, the present invention is not limited to any particular type of website.

As shown, website 1200 includes a plurality of selectable icons for accessing various websites (e.g. website A, website B, website C, etc.). Additionally, website 1200 displays three advertisements (ads 1201-1203). In typical embodiments, at least one of ads 1201-1203 is an advertisement for a product or service provided by the sponsor. For example, if the sponsor is a bank, at least one of ads 1201-1203 can advertise a banking service provided by the bank. In other embodiments, some or all of ads 1201-1203 can advertise products or services offered by entities related to or independent of the sponsor.

Website 1200 can be customized for a particular user. In other words, to view website 1200, the user can be required to log in. In such cases, the website icons displayed can be customized to the logged in user. For example, when website 1200 offers a password manager service, each website icon can represent a website for which the password manager service stores the user's credentials for logging the user in to the corresponding website as described above.

Additionally, in some embodiments, one or more of ads 1201-1203 can be selected or customized for the user, although the invention does not require the selection or customization of ads for any particular user. In either case, when the user selects one of ads 1201-1203, website 1200 can cause one or more notifications to be generated which identify that the user has selected a particular ad (which causes the display of a webpage or other interface with further information about the advertised product or service).

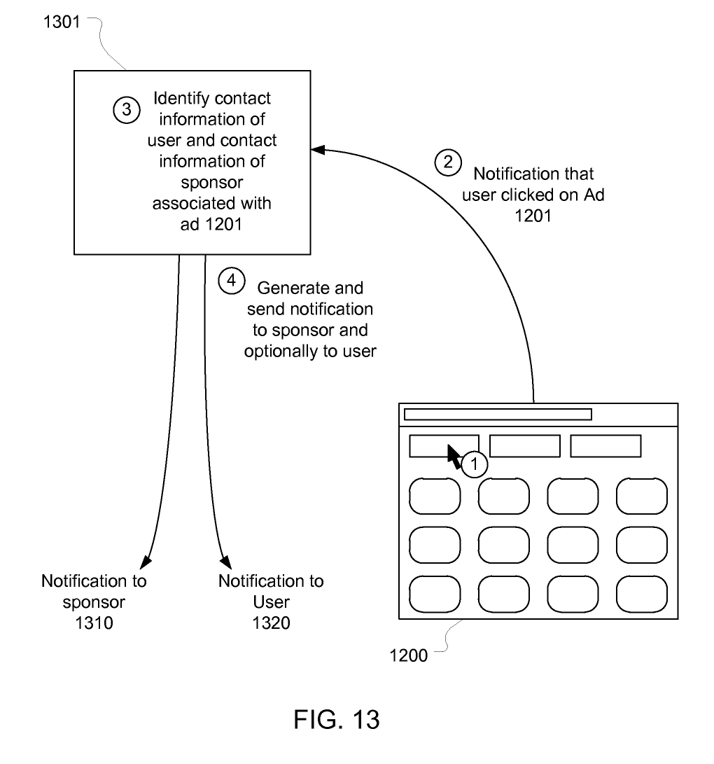

FIG. 13 represents the process that occurs to generate the one or more notifications. First, as represented by the arrow over ad 1201, the user clicks on one of the displayed ads in website 1200. In response to this click, a webpage to which ad 1201 is linked can be opened on the user's computer (not shown).

Second, a notification is sent to a server system 1301 indicating that the user has clicked on ad 1201. The sending of this notification can be implemented using known techniques. This notification can include sufficient information to identify what ad was clicked and which user clicked the ad (e.g. by including a username or other identifier of the user).

Third, server system 1301 processes the information contained in the notification received in step 2 and identifies contact information of the user. For example, server system 1301 can identify a username or other identifier of the user that is included in the notification and lookup a name, email address, phone number, or other information about the user. Similarly, server system 1301 can identify contact information associated with the selected ad. For example, a sponsor can specify that, when ad 1201 is clicked, a notification should be sent to a particular department or individual of the sponsor. The appropriate contact information for the department or individual can be stored on server system 1301 with an association to one or more ads.

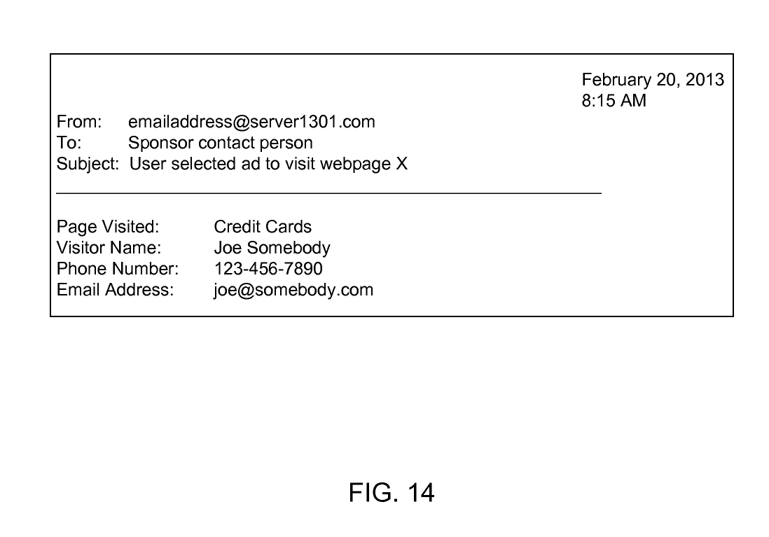

Fourth, server system 1301 generates and sends one or more notifications. Specifically, server system 1301 can identify the sponsor's contact information associated with ad 1201 and send a notification 1310 using that contact information that includes the contact information of the user. An example of a notification 1310 is shown in FIG. 14.

By receiving notification 1310, the sponsor can better respond to the user's apparent interest in ad 1201. For example, the sponsor can contact the user to provide additional information about the advertised product or service, send additional offers related to the advertised product of service, track the success of the ad, etc.

In some embodiments, a notification 1320 may also be sent to the user that clicked on the ad. For example, notification 1320 can provide additional information about the advertised product or service, provide additional offers related to the advertised product of service, thank the user for viewing the ad, etc. Further, in some embodiments, the webpage displayed in response to the user clicking the ad can be customized for the user.

By generating notifications in response to a user's selection of an ad, the present invention enhances a sponsor's ability to capitalize on a user's apparent interest in a product or service. In many cases, the ads that cause notifications to be generated are ads related to the sponsor's goods or services. However, it is also possible to generate notifications when an ad not related to the sponsor is selected.

Further, because the sponsor can configure where the notification 1310 is sent when each ad is selected, the appropriate people at the sponsor can be immediately notified of the user's selection of the ad. For example, if a first displayed ad relates to loans provided by a bank, the loan department can be notified when the first ad is selected. Similarly, if a second displayed ad relates to checking services provided by the bank, the checking department can be notified when the second ad is selected.

A sponsor can also have the ability to configure what information about the user is included in notification 1310. For example, a sponsor can specify that only an email address be included when one ad is selected, but that a phone number is also included when another ad is selected. Further, although the above description refers to a single notification 1310, it is equally possible to send more than one notification 1310 to the sponsor (e.g. by sending a notification 1310 to many different email addresses, individuals, departments, etc.).

Server system 1301 and/or a sponsor's computer system can also track the selection of ads as well as the response to notifications 1310, 1320 to facilitate improvements to the notification system. For example, it can be determined which type of notifications generate the best user response, which types of ads are most closely linked to a favorable user response to a notification, etc. Future ads or notifications can be enhanced based on this tracked information.

Rotating the Source of Advertisements

In some embodiments, a website, such as website 1200 shown in FIG. 12, can be configurable to allow an administrator to rotate the source of advertisements that are displayed on the website. For example, a typical website, when loaded, will obtain an advertisement (e.g. ad 1201, 1202, or 1203) from a particular source, and the advertisement will remain the same as long as the website is displayed (i.e. until reloaded).

There can be many different sources for advertisements. For example, Google's AdSense is an advertising platform that delivers an ad to a webpage when requested. AdBrite provides a similar platform to AdSense. With both of these platforms, the webpage developer does not have complete control over which ads are displayed. For example, AdSense provides ads that are contextually related to the content of the webpage in which the ad is displayed. Ads can also be obtained from a custom source such as ads related to the owner of the webpage or ads provided by a third party that pays to advertise on the webpage.

Some ads may be dynamic in that the displayed content may be updated without requiring the webpage to be reloaded. In such cases, however, the source of the ad, whether static or dynamic, remains the same. For example, if a particular advertisement box in a webpage is assigned an ad from the Google AdSense network, when the page is loaded, the AdSense network will provide an ad for display (which may be a series of ads for display (e.g. as a slideshow) which all originate from the same source).

The present invention provides the ability to rotate the source of an ad without requiring the page to be reloaded. For example, if, when the webpage is initially loaded, an ad from the Google AdSense network is obtained for display in a first portion of the webpage, the AdSense ad can be replaced with an ad obtained from a different source without requiring the webpage to be reloaded.

In some embodiments, the webpage can be configured to update the source of a particular ad on an interval such as every few seconds. For example, the webpage can initially display a first ad obtained from the Google AdSense network, and then five seconds later replace the first ad with a second ad obtained from a custom source (e.g. an ad related to the sponsor). By rotating the source of an ad, the webpage is more likely to display an ad in which the user will be interested and ultimately an ad that will generate revenue for the webpage.

In a particular implementation, this rotation of ad sources can be accomplished by including logic in the webpage that causes a frame or other portion of the webpage to be refreshed (as opposed to the entire webpage). Each time the frame is refreshed, a new ad can be obtained for display. A setting within the logic can specify from which source each new ad should be obtained. For example, if an administrator configures the webpage to use two sources for obtaining ads to be displayed within a particular frame of the webpage, each instance of the webpage can include the necessary logic to cause the rotation between the two sources.

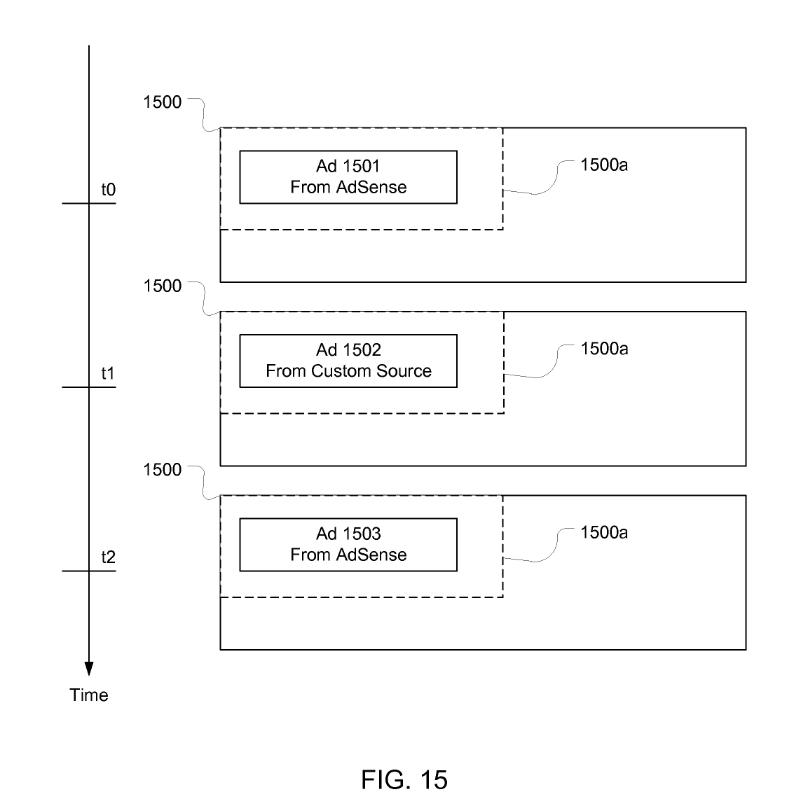

FIG. 15 illustrates an example of how this rotation can occur. A version of a webpage 1500 is shown at three different times (t0, t1, t2). Webpage 1500 includes a frame 1500a in which an ad is displayed. Initially, at time t0, this ad is ad 1501 which is obtained from the Google AdSense network. At time t1, logic within webpage 1500 causes frame 1500a to refresh. As part of this refresh, a request is made to a different source, Custom Source, for ad 1502. Accordingly, after time t1, ad 1502 is displayed within frame 1500a in place of ad 1501. Again, at time t2, logic within webpage 1500 causes frame 1500a to refresh. As part of this refresh, a request is made to the Google AdSense network to obtain ad 1503 which is displayed within frame 1500a in place of ad 1502.

Although the example of FIG. 15 uses two sources, more than two sources can also be used. In any case, the logic in the webpage causes a request to be made to the appropriate source each time the frame is refreshed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, performed by a server computing system, for generating notifications of a user's selection of an advertisement, the method comprising:
receiving, from a client computing system, a first notification that a user has selected an advertisement being displayed on the client computing system, the first notification including an identification of the user and an identification of the advertisement that was selected;
based on the identification of the user, identifying contact information of the user;
based on the identification of the advertisement, identifying contact information of a sponsor that is associated with the advertisement;
generating a second notification that identifies that the user has selected the advertisement; and
sending the second notification to an address contained within the contact information of the sponsor that is associated with the advertisement.

2. The method of claim 1, wherein the identification of the user contained in the first notification comprises a username of the user.

3. The method of claim 1, wherein identifying contact information of the user comprises identifying one or more of:
an email address;
a social networking address;
a phone number; or
a physical address.

4. The method of claim 1, wherein identifying contact information of a sponsor that is associated with the advertisement comprises identifying one or more email addresses associated with the advertisement.

5. The method of claim 4, wherein the one or more email addresses comprise one or more email addresses of a person that works for the sponsor or a department of the sponsor that manages a product or service advertised in the advertisement.

6. The method of claim 1, further comprising:
generating a third notification; and
sending the third notification to an address contained within the contact information of the user.

7. The method of claim 6, wherein the third notification contains information related to a product or service that was advertised in the advertisement.

8. The method of claim 1, further comprising:
receiving, from the sponsor associated with the advertisement, updated contact information for the advertisement; and
storing the updated contact information in association with the advertisement such that, when another user selects the advertisement, a notification is sent using the updated contact information.

9. The method of claim 1, wherein the advertisement is displayed within a webpage that provides a password manager service.

10. One or more computer storage media storing computer executable instructions which implement a webpage, the computer executable instructions including:
logic which, when executed by one or more processors, renders a webpage, the webpage including a frame in which one or more advertisements are displayed;
logic which causes the webpage to request a first advertisement from a first source to be displayed in the frame; and
logic which, after the first advertisement has been displayed in the first frame for a specified period of time, causes the webpage to refresh the frame and, as part of the refresh, request a second advertisement from a second source to be displayed in the frame in place of the first advertisement.

11. The one or more computer storage media of claim 10, wherein the first source is a third party online advertising system.

12. The one or more computer storage media of claim 11, wherein the second source is a first party source that provides the webpage.

13. The one or more computer storage media of claim 12, wherein the first party source provides advertisements for advertising a product of service offered by a sponsor of the webpage.

14. The one or more computer storage media of claim 13, wherein the webpage comprises a password management service.

15. The one or more computer storage media of claim 10, wherein the computer executable instructions further include:
logic which, after the second advertisement has been displayed in the first frame for a specified period of time, causes the webpage to refresh the frame and, as part of the refresh, request a third advertisement from the first source to be displayed in the frame in place of the second advertisement.

16. The one or more computer storage media of claim 10, wherein the computer executable instructions further include:
logic which displays one or more icons that each represent a website; and
logic, which when an icon is selected by a user, causes an instance of the corresponding website to be opened with the user logged in to the website.

17. The one or more computer storage media of claim 10, wherein the computer executable instructions further include:
logic for notifying a server computing system when a user selects an advertisement displayed within the webpage, the notification identifying the user that selected the advertisement.

18. A method, performed by a server computing system, for verifying user credentials for a particular website, the method comprising:
receiving, from a user, a request to add a first website to a password manager system, the request providing user credentials for logging in to the first website;
accessing logic, stored on the server computing system, which defines interactions to be performed with a server computing system that hosts the first website to log the user in to the first website;
executing the logic to perform the interactions using the user credentials;
receiving an instance of the first website, the user being logged in to the instance of the first website;
accessing logic, stored on the server computing system, which defines interactions to be performed with the server computing system that hosts the first website to log the user out of the first website; and
executing the logic to log the user out of the first website.

19. The method of claim 18, further comprising:
notifying the user that the user credentials provided in the request were successfully used to log the user in to the first website.

20. The method of claim 18, further comprising:
storing the user credentials to enable the user credentials to be used to log the user in to the first website when the user subsequently requests to be logged in to the first website.
